(19) United States
(12) Patent Application Publication
(10) Pub. No.: US 2003/0210631 A1
(43) Pub. Date: Nov. 13, 2003

(54) Determination of maximum storage capacity of optical information record medium

(75) Inventors: Shun-Yi Tung, Taoyuan (TW); Hsin-Tung Yu, Taoyuan (TW); Kuo-Hsien Cheng, Taoyuan (TW)

Correspondence Address: TROXELL LAW OFFICE PLLC, SUITE 1404, 5205 LEESBURG PIKE, FALLS CHURCH, VA, 22041, US

(73) Assignee: Benq Corporation

(21) Appl. No.: 10/430,347

(22) Filed: May 7, 2003

(30) Foreign Application Priority Data
May 7, 2002 (TW) 91109503

(51) Int. Cl. G11B 7/00

(52) U.S. Cl. 369/53.24

(57) ABSTRACT

The invention is to provide a method for determining a maximum storage capacity of an optical information record medium having a pregroove on which predetermined address codes are marked. The method is performed by detecting the last physical predetermined address code of the predetermined address codes. The maximum storage capacity is represented in terms of time by a time value representative of the detected last physical predetermined address code.

### FIELD OF THE INVENTION

The present invention relates to a method for determining a maximum storage capacity of an optical information record medium with a pregroove on which a plurality of predetermined address codes are marked, e.g., Absolute Time In Pregroove (ATIP) codes.

### BACKGROUND OF THE INVENTION

The prior art write strategy for an optical record medium, such as a CD-R (compact disk recordable), a CD-RW (compact disk rewritable), a MO-disk (magneto-optical disk), and the like, is usually to form a pregroove on the optical record medium. There are predetermined address codes marked on the pregroove, such as absolute time in pregroove codes (ATIP codes). ATIP codes provide a tracking basis-to help an optical information recording/reproducing apparatus (such as CD-RW player) to record and read data. Typically, the predetermined address codes are represented in terms of time. About the prior art of the write strategy of the optical record media with the pregroove and predetermined address codes and the specification, please refer to the U.S. Pat. No. 5,226,027 and “Compact Disc Recordable System Description”, the orange book in the 3^{rd} edition published by Philips corporation in 1997.

Most of the optical record media provide information on the last possible predetermined address code according to the specification. Such information is used as a suggestion of the maximum storage capacity for the optical record medium. Usually the information on the last possible predetermined address code is stored in the data management area of the optical record medium in advance. Take CD-R as an example. In the orange book, the specification for CD-R designates the last possible ATIP as Special information 3. It must be emphasized that such maximum storage capacity for the optical record medium is merely a suggestion value but not its real maximum storage capacity. Usually, after the optical record medium is made, there are more predetermined address codes existing beyond the last possible predetermined address code.

When an optical information recording/reproducing apparatus records data onto the optical record medium, the optical information recording/reproducing apparatus reads the information on the last possible predetermined address code and further uses the maximum storage capacity corresponding to the last possible predetermined address code (which is merely a suggestion value) as basis to record information.

However, in practice, the information which user wants to record on the optical record medium is often more than the maximum storage capacity corresponding to the last possible predetermined address code. Take CD-R as an example. The maximum storage capacity corresponding to the last possible predetermined address code designated by the specification is 74 minutes. It must be noted that every one more minute for recording equals to 9.2 Mb data being recorded on CD-R. In other words, some storage capacity of the optical record medium will be wasted, if use the information on last possible predetermined address code given by the optical record medium to determine the maximum storage capacity, as designated by the specification.

Moreover, when information or data which user wants to record onto the optical record medium is more than the maximum storage capacity corresponding to the last possible predetermined address code, data record failure will occur under the DAO (Disk-at-once) mode. Or data record failure in the last track will occur under the TAO (Track-at-once) mode.

Some of the present optical information recording/reproducing apparatuses provide a function to ignore the maximum storage capacity corresponding to the last possible predetermined address code designated by the specification. Such optical information recording/reproducing apparatuses directly record data. Such method is convenient. However, if data is larger than the real maximum storage capacity of the optical record medium, data record failure will still occur.

Therefore, one object of the present invention is to determine the real maximum storage capacity of the optical record medium, in order to effectively utilize the storage capacity of the optical record medium.

### SUMMARY OF THE INVENTION

The present invention relates to a write strategy and to determine the maximum storage capacity for an optical record medium with a pregroove on which plurality of predetermined address codes (such as: Absolute Time In Pregroove codes, ATIP) are marked. Therefore, the storage capacity of the optical record medium can be used effectively.

According to the first preferred embodiment of the invention, a method is provided for deciding a maximum storage capacity of an optical record medium. The optical record medium has a pregroove on which a plurality of predetermined address codes (such as ATIP) are marked. According to the method of the first preferred embodiment, firstly scan the pregroove forward until the last physical predetermined address code of the plurality of predetermined address codes is detected. Then represent the maximum storage capacity in terms of time with a time value representative of the detected last physical predetermined address code.

According to the second preferred embodiment of the invention, the optical record medium has a pregroove on which a plurality of predetermined address codes (such as ATIP) are marked. There is a predetermined information, recorded on the optical information record medium, indicating the last possible predetermined address code of the plurality of predetermined address codes. According to the second preferred embodiment of the invention, first is to retrieve the predetermined information from the optical information record medium. Next, according to the retrieved predetermined information, scan the pregroove, and seek out the last possible predetermined address code. Then, start at the last possible predetermined address code to scan the pregroove forward until the last physical predetermined address code of the plurality of predetermined address codes is detected. Finally, represent the maximum storage capacity in terms of time with a time value representative of the detected last physical predetermined address code.

According to the third preferred embodiment of the invention, a method is provided for determining a first maximum storage capacity of a first optical information record medium. This method uses a second maximum storage capacity of a second optical information record medium, the second maximum storage capacity being previously determined and provided. According to the third preferred embodiment of the invention, first is to judge whether the first optical information record medium is identical to the second optical information record medium. Next, if the judgment is yes, determine that the first maximum storage capacity equals to the second maximum storage capacity.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a schematic diagram showing the configuration and function devices of an information record apparatus in which the invention method can be used.

FIG. 2 is a flowchart showing a method to determine the maximum storage capacity of an optical record medium according to the present invention.

FIG. 3A is a flowchart showing a way to scan the pregroove and to judge the last physical predetermined address code shown in FIG. 2.

FIG. 3B is a flowchart showing an alternative way to scan the pregroove and to judge the last physical predetermined address code shown in FIG. 2.

FIG. 3C is a flowchart showing another alternative way of the present invention to scan the pregroove and to judge the last physical predetermined address code shown in FIG. 2.

FIG. 4 is a flowchart showing a method to determine the maximum storage capacity of an optical record medium according to a second preferred embodiment of the invention.

FIG. 5 is a flowchart showing a method to determine the maximum storage capacity of an optical record medium according to a third preferred embodiment of the invention.

### DETAILED DESCRIPTION OF THE INVENTION

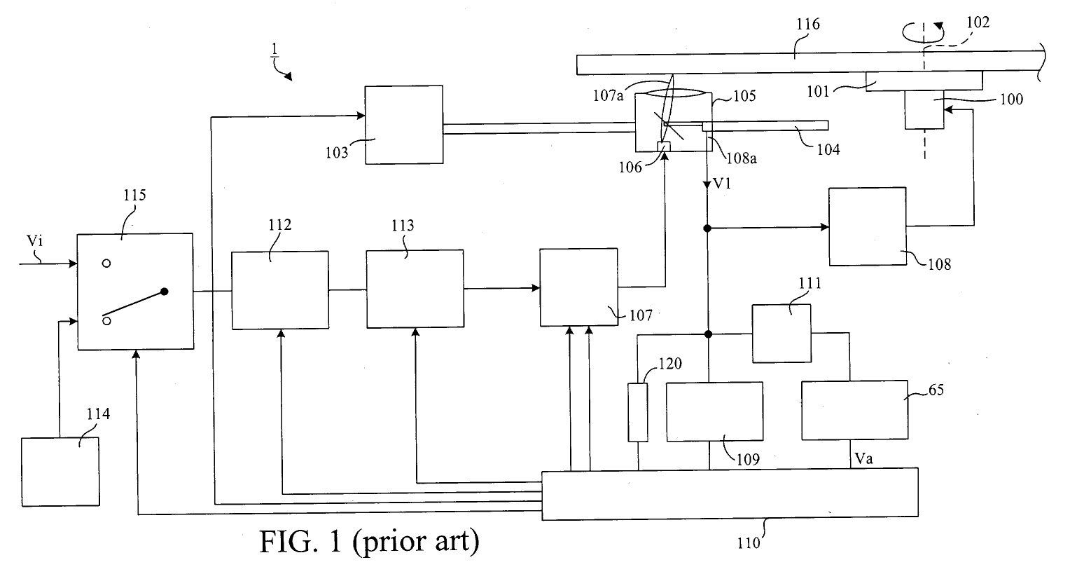

Referring to FIG. 1, FIG. 1 is a schematic diagram showing the configuration and function devices of an information record apparatus 1, in which the invention method can be used. The information record apparatus 1 is of a conventional type. The information record apparatus 1 records optical signals (information patterns) of a suitable recording format on an optical record medium 116. The recording format can be standard CD format, RDAT format or others. The optical record medium 116 may be of a type with a radiation-sensitive layer, e.g., a phase-change material or a dye, providing servo track used for recording the information patterns.

In general, the servo track of the record medium 116 has a track modulation, which is usually implemented in track wobble, i.e., a wobbled pregroove is formed on the record medium 116 as the track wobble. In the track wobble, the frequency is modulated in conformity with an address information signal in form of ATIP (Absolute time in pregroove) codes.

An optical read/write head 105 of a conventional type is arranged opposite to the record medium 116. The record medium 116 rotates relative to an axis 102. The optical read/write head 105 can be moved in a radial direction relative to the record medium 116 by a positioning device of a conventional type. As shown in FIG. 1, the positioning device can be in the form of a motor 103 and a spindle 104, for example. The read/write head 105 can be employed both for recording information patterns and for reading information patterns.

For the purpose to record and read information, the read/write head 105 comprises a semiconductor laser for generating a radiation beam 107a whose intensity is variable by means of a control circuit 107. The radiation beam 107a aims at the servo track of the record medium 116. The radiation beam 107a is partially reflected from the record medium 116. If an information pattern has been recorded, the reflected beam is modulated in conformity with the track wobble and, also in conformity with the information pattern. The reflected beam is directed towards a radiation sensitive detector 108a, which generates a read signal V1 corresponding to the beam modulation. A signal V1 includes a component produced by the track wobble and has a frequency of approximately 22 kHz at the nominal scanning velocity. A motor control circuit 108 is used for controlling a motor 100. The motor speed is controlled so as to maintain the frequency of the component produced in the read signal V1 by the track wobble at substantially 22 kHz.

A driving device comprising the motor 100 and a turntable 101 is used to drive the record medium 116 rotating relative to the axis 102. The read signal V1 is applied to a detection circuit 109. The detection circuit 109 derives the ATIP codes from the component produced in the read signal V1 produced by the track wobble and applies these codes to a processing unit including, for example, a microcomputer 110. Moreover, the read signal V1 is applied to an amplifier circuit 111. The amplifier circuit 111 has a high-pass characteristic to reject the signal components produced in the read signal V1 by the track wobble. Thus, low-frequency components have been removed from the read signal V1. The read signal V1 without low-frequency components is applied to the analysis circuit 65 which indicates the quality of the read information patterns. An embodiment of the analysis circuit 65 will be described later. An analysis signal Va on the output of the analysis circuit 65 is also applied to the microcomputer 110.

The information record apparatus 1 further comprises a conventional CIRC (cross interleaved Reed-Solomon codes) encoding circuit 112. A signal Vi to be recorded can be applied to the encoding circuit 112 via a switch 115 controlled by the microcomputer 110. The CIRC encoding circuit 112 is arranged in series with a conventional EFM modulator 113. The EFM modulator 113 has its output connected to the driver circuit 107. The driver circuit 107 is of a conventional controllable type. Its parameters which influence the quality of the recorded information pattern can be adjusted. For example, the parameter may be the intensity of the radiation beam during the formation of the information patterns. In the case that the information patterns are formed subsequently with radiation pulses of a constant duration, this duration may be an important parameter for influencing the quality of the applied information pattern.

In the case of magneto-optical recording, the strength of the magnetic field generated in the record-carrier area scanned by the radiation beam may be an important parameter. For the purpose of generating a test pattern, the information record apparatus 1 may includes a test signal generator 114, which generates a random digital signal or which generates a signal corresponding to the digital signal value zero (digital silence), for example. It is noted that in principle, the information signal can also be used for the formation of test patterns. The signal generated by the signal generator 114 is applied to the CIRC encoding circuit 112 via the switch 115. The switch 115 is of a conventional type which transfers either the signal Vi to be recorded or the output signal of the signal generator 114, depending on the control signal received from the control unit 110. In addition, to detect a high-frequency signal component in the read signal V1, the information record apparatus 1 may includes a high-frequency detector 120 arranged between the read/write head 105 and the microcomputer 110.

The present invention relates to a method for determining the maximum storage capacity of the optical record medium 116 or similar optical record medium by scanning the last physical predetermined address code of the plurality of the predetermined address codes on the optical record medium 116 or similar optical record medium. The optical record medium 116 or similar optical record medium mentioned above has a pregroove. The plurality of predetermined address codes (such as ATIP) are marked on the pregroove. The optical record medium 116 will be used below for describing the present invention. By describing several preferred embodiment thoroughly, point out the spirit and characteristics of the invention.

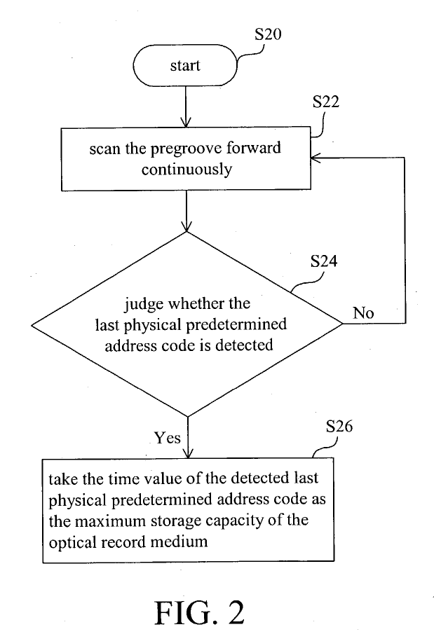

Please refer to FIG. 2. FIG. 2 is a flowchart showing a method to determine the maximum storage capacity of an optical record medium 116 according to the present invention. The method is provided to determine a maximum storage capacity of the optical record medium 116 or similar optical record medium. According to the first preferred embodiment of the invention, performing the following steps, as shown in FIG. 2:

Step S20: to set initial conditions;

Step S22: to scan the pregroove forward continuously;

Step S24: to judge whether the last physical predetermined address code of the plurality of predetermined address codes is detected, and if NO, go to step S22;

Step S26: to take the time value of the detected last physical predetermined address code as the maximum storage capacity of the optical record medium 116.

In Step S24, if the judgment is YES, it means that the last physical predetermined address code of the plurality of predetermined address codes is detected. Therefore, the maximum storage capacity can be determined. Using CD-R as an example, if the detected last physical predetermined address code represents a time value for 86 minutes, the maximum storage capacity of the CD-R is 86 minutes.

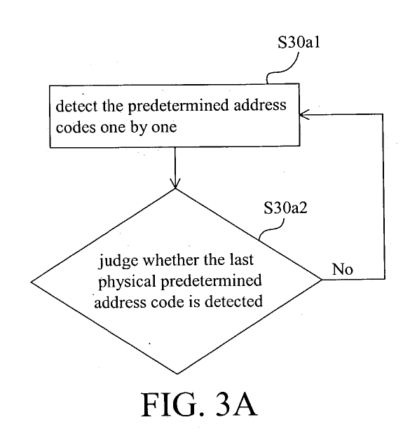

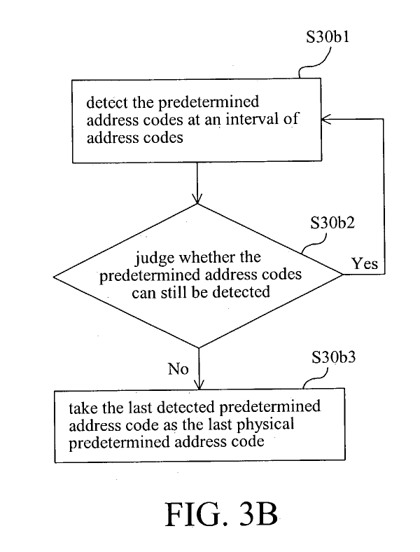

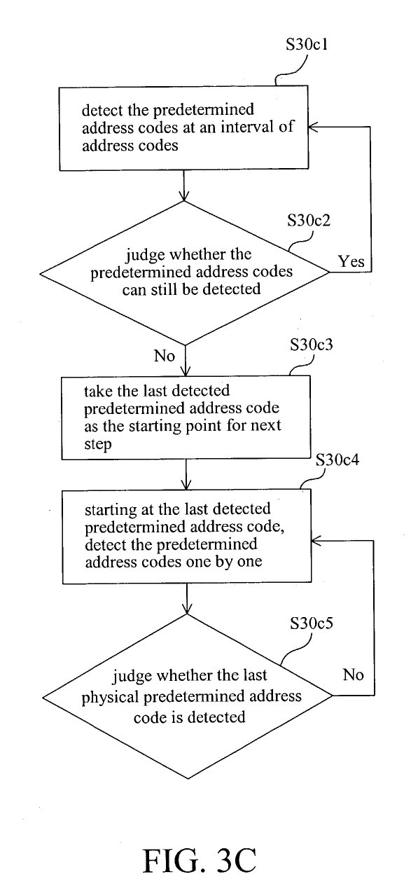

Steps S22 and S24 can be implemented in many ways. Please refer to FIGS. 3A and 3B. FIG. 3A is a flowchart showing a way to scan the pregroove and to judge the last physical predetermined address code shown in FIG. 2. FIG. 3B is a flowchart showing an alternative way of the present invention to scan the pregroove and to judge the last physical predetermined address code shown in FIG. 2. As shown in FIG. 3A, in step S30a1 detect the predetermined address codes one by one. Then, in step S30a2 judge whether the last physical predetermined address code of the plurality of predetermined address codes is detected. If YES in step S30a2, the steps from S22 to S24 are completed. If NO in step S30a2, go back to Step S30a1.

The way shown in FIG. 3A to detect the predetermined address codes one by one can ensure that the last physical predetermined address code in the plurality of predetermined address codes is detect. However, it is time consuming.

Therefore, an alternative way can be used to save time. As shown in FIG. 3B, in Step S30b1 detect the predetermined address codes at an interval of address codes. Then, in step S30b2 judge whether the predetermined address codes can still be detected. If it is YES in step S30b2, go back to step S30b1. If NO in step S30b2, go to Step S30b3 to take the last detected predetermined address code as the last physical predetermined address code.

Although the way shown in FIG. 3B to detect the predetermined address codes at an interval of address codes can save some time, it may not accurately detect the last physical predetermined address code.

Please refer to FIG. 3C. FIG. 3C is a flowchart showing another alternative way of the present invention to scan the pregroove and to judge the last physical predetermined address code shown in FIG. 2. In one embodiment as shown in FIG. 3C perform the following steps to scan the pregroove and to judge the last physical predetermined address code:

Step S30c1: to detect the predetermined address codes at an interval of address codes;

Step S30c2: to judge whether the predetermined address codes can still be detected, and if YES, go back to Step S30c1;

Step S30c3: to take the last detected predetermined address code as the starting point for next step;

Step S30c4: starting at the last detected predetermined address code, to detect the predetermined address codes one by one;

Step S30c5: to judge whether the last physical predetermined address code of the plurality of predetermined address codes is detected, and if NO, go back to Step S30c4.

If YES in step S30c5, the steps from S22 to S24 shown in FIG. 2 are completed. Comparing to the ways shown in FIGS. 3A and 3B, the way shown in FIG. 3C can be used to efficiently and accurately detect the last physical predetermined address code.

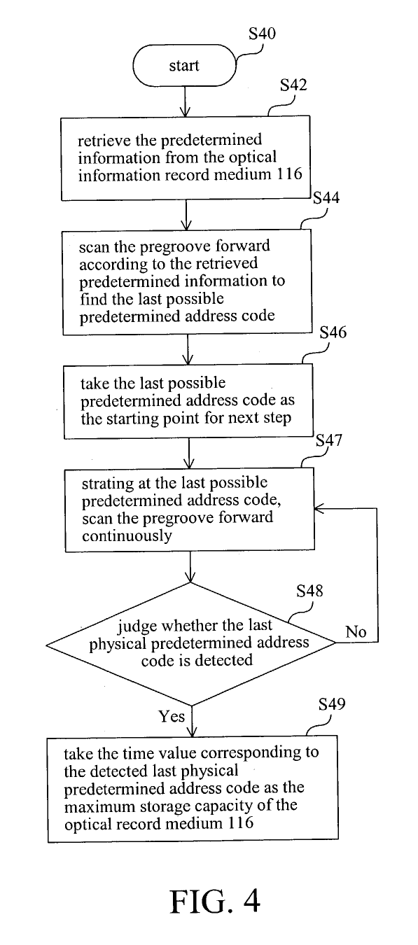

As described before, there are predetermined information on the last possible predetermined address code recorded on original optical information record media. The other method of the invention uses that predetermined information on the last possible predetermined address code. Please refer to FIG. 4. FIG. 4 is a flowchart showing a method to determine the maximum storage capacity of an optical record medium according to a second preferred embodiment of the invention. The method is provided to decide a maximum storage capacity of the optical record medium 116 or similar optical record medium on which the predetermined information is recorded. The predetermined information indicates the last possible predetermined address code of the plurality of predetermined address codes. According to the second preferred embodiment of the invention shown in FIG. 4, perform the following steps:

Step S40: to set initial conditions;

Step S42: to retrieve the predetermined information from the optical information record medium 116;

Step S44: to scan the pregroove forward according to the retrieved predetermined information to find the last possible predetermined address code;

Step S46: to take the last possible predetermined address code as the starting point for next step;

Step S47: starting at the last possible predetermined address code, to scan the pregroove forward continuously;

Step S48: to judge whether the last physical predetermined address code of the predetermined address codes is detected, if NO, go back to step S47, and if YES, perform step S49;

Step S49: to take the time value corresponding to the detected last physical predetermined address code as the maximum storage capacity of the optical record medium 116.

In step S48, if the judgment is YES, it means that the last physical predetermined address code of the predetermined address codes is detected. Therefore, the time value corresponding to the detected last physical predetermined address code can be taken as the maximum storage capacity of the optical record medium 116.

About the ways to scan the pregroove in step S47 and the way to judge whether the last physical predetermined address code of the predetermined address codes is detected in step S48, there are many alternatives. The steps from S30a1 to step S30a2 showed in FIG. 3A can be adopted. The steps from S30b1 to step S30b3 showed in FIG. 3B can be adopted. And the steps from S30c1 to step S30c5 showed in FIG. 3C can be adopted as well.

This invention can be applied in more convenient and efficient ways. The other method for applying the invention is to determine the maximum storage capacity of each types of optical record media made by different manufacturers in advance, and to store information of types and their maximum storage capacities for later use. When the maximum storage capacity for an optical record medium needs to be determined, the information of type for this optical record medium will be read first. Then, according to the information of type read, compare it with the information of types previously stored until find the optical record medium with identical information of type. And take the maximum storage capacity of the optical record medium found as the maximum storage capacity of the optical record medium wish to be determined. About the implement mentioned upon, the details will be described in the third preferred embodiment of the invention.

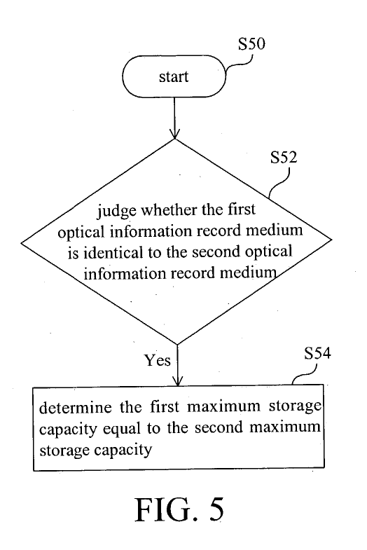

Please refer to FIG. 5. FIG. 5 is a flowchart showing a method to determine the maximum storage capacity of an optical record medium according to a third preferred embodiment of the invention. The third preferred embodiment of the invention is to decided to a maximum storage capacity of the optical record medium 116 or similar optical record medium. The optical record medium to be determined its maximum storage capacity is called the first optical record medium. The maximum storage capacity of the first optical record medium is called the first maximum storage capacity. In the third preferred embodiment of the invention, the method utilizes the maximum storage capacity of a second optical record medium (called the second maximum storage capacity). The second maximum storage capacity has been determined and provided in advance.

According to the second preferred embodiment of the invention shown in FIG. 5, perform the following steps:

Step S50: to start and to set up initial conditions;

Step S52: to judge whether the first optical information record medium is identical to the second optical information record medium; and if YES, perform step S54;

Step S54, to decide that the first maximum storage capacity equals to the second maximum storage capacity.

Step S52 will be described in details. The first optical information record medium has its first information of types recorded on it. The second information of types of the second optical information record medium is provided in advance. In step S52, initially retrieve the first information of type from the first optical information record medium, then compare the first information and the second information to judge whether the two information of types are identical. If the judgment is YES, confirm the first optical information record medium is identical to the second optical information record medium.

In practice, besides the second optical information record medium, the maximum storage capacities of each types of optical record media made by different manufacturers have been determined and provided previously. If the judgment is NO, compare the information of type of the first optical information record medium to other information of types of other optical record media until an optical record medium identical to the first optical information record medium is found. Then, it can be decided that the first maximum storage capacity of the first optical information record medium equals to the predetermined maximum storage capacity of the optical record medium found.

The determination of the maximum storage capacity for the second optical information record medium and other optical information record media from different manufacturers can be performed by the first preferred embodiment of the invention or the second preferred embodiment of the invention. Moreover, the method of scanning the pregroove forward and the method for judging whether the last physical predetermined address code is detected can be performed by adopting steps from S30a1 to S30a2 showed in FIG. 3A, steps from S30b1 to S30b3 showed in FIG. 3B, or steps from S30c1 to S30c5 showed in FIG. 3C.

In contrast to the prior art method, in the method for determining the maximum storage capacity of the optical information record medium according to the present invention, the last physical and also real last predetermined address code on optical information record medium is detected to decide the maximum storage capacity of the optical information record medium. Therefore, the present invention can avoid the drawbacks of the prior art method using the last possible predetermined address code to determine the maximum storage capacity.

While CD-R disks are used as examples to explain the preferred embodiments of the invention, the invention can be also applied to other disk types, such as MD, MO, CD-RW, DVD-R, DVD-RW, DVD-RAM and the like.

While the invention has been described in the preferred embodiments, it is understood that the words which have been used are words of description rather than words of limitation and that changes within the purview of the appended claims may be made without departing from the scope and spirit of the invention in its broader aspect.

What is claimed is:

1. A method for determining a maximum storage capacity of an optical information record medium having a pregroove on which a plurality of predetermined address codes are marked, said method comprising the steps of:
(a) scanning the pregroove forward until a last physical predetermined address code of the plurality of predetermined address codes is detected; and
(b) representing said maximum storage capacity in terms of time with a time value representative of the detected last physical predetermined address code.

2. The method of claim 1, wherein the plurality of predetermined address codes, marked on the pregroove, are Absolute Time In Pregroove (ATIP) codes.

3. The method of claim 2, wherein step (a) is performed by the steps of:
(a1) detecting the plurality of predetermined address codes one by one; and
(a2) continuously detecting the plurality of predetermined address codes until the last physical predetermined address code is detected.

4. The method of claim 2, wherein step (a) is performed by the steps of:
(a1) detecting the plurality of predetermined address codes at an interval of address codes; and
(a2) continuously detecting the plurality of predetermined address codes until the last physical predetermined address code is detected.

5. The method of claim 2, wherein step (a) is performed by the steps of:
(a1) detecting the plurality of predetermined address codes at an interval of address codes until a last detectable predetermined address code is detected; and
(a2) starting at the last detectable predetermined address code, detecting the plurality of predetermined address codes forward until the last physical predetermined address code is detected.

6. A method for determining a maximum storage capacity of an optical information record medium having a pregroove on which a plurality of predetermined address codes are marked, a predetermined information, recorded on the optical information record medium, indicating a last possible predetermined address code of the plurality of predetermined address codes, said method comprising the steps of:
(a) retrieving the predetermined information from said optical information record medium;
(b) according to the retrieved predetermined information, scanning the pregroove, and seeking out the last possible predetermined address code;
(c) starting at the last possible predetermined address code, scanning the pregroove forward until a last physical predetermined address code of the plurality of predetermined address codes is detected; and
(d) representing said maximum storage capacity in terms of time with a time value representative of the detected last physical predetermined address code.

7. The method of claim 6, wherein the plurality of predetermined address codes, marked on the pregroove, are Absolute Time In Pregroove (ATIP) codes, and the predetermined information, recorded on the optical information record medium, indicates the last possible ATIP code.

8. The method of claim 7, wherein step (c) is performed by the steps of:
(c1) detecting the plurality of predetermined address codes one by one; and
(c2) continuously detecting the plurality of predetermined address codes until the last physical predetermined address code is detected.

9. The method of claim 7, wherein step (c) is performed by the steps of:
(c1) detecting the plurality of predetermined address codes at an interval of address codes; and
(c2) continuously detecting the plurality of predetermined address codes until the last physical predetermined address code is detected.

10. The method of claim 7, wherein step (c) is performed by the steps of:
(c1) detecting the plurality of predetermined address codes at an interval of address codes until a last detectable predetermined address code is detected; and
(c2) starting at the last detectable predetermined address code, detecting the plurality of predetermined address codes forward until the last physical predetermined address code is detected.

11. A method for determining a first maximum storage capacity of a first optical information record medium by use a second maximum storage capacity of a second optical information record medium, the second maximum storage capacity being previously determined and provided, said method comprising the steps of:
(a) judging whether said first optical information record medium is identical to said second optical information record medium; and if yes
(b) if YES in step (a), determining the first maximum storage capacity equal to the second maximum storage capacity.

12. The method of claim 11, wherein said first optical information record medium has a first type information recorded thereon, a second type information relating to said second optical information record medium is previously provided, and step (a) is performed by the steps of:
(a1) retrieving the first type information from said first optical information record medium;
(a2) judging whether the first type information is equal to the second type information; and
(a3) if YES in step (a2), identifying said first optical information record medium being identical to said second optical information record medium.

13. The method of claim 12, wherein said second optical information record medium has a pregroove on which a plurality of predetermined address codes are marked, and the second maximum storage capacity is determined by the steps of:
(c) scanning the pregroove forward until a last physical predetermined address code of the plurality of predetermined address codes is detected; and
(d) representing said second maximum storage capacity in terms of time with a time value representative of the detected last physical predetermined address code.

14. The method of claim 13, wherein the plurality of predetermined address codes, marked on the pregroove, are Absolute Time In Pregroove (ATIP) codes.

15. The method of claim 14, wherein step (c) is performed by the steps of:
(c1) detecting the plurality of predetermined address codes one by one; and
(c2) continuously detecting the plurality of predetermined address codes until the last physical predetermined address code is detected.

16. The method of claim 14, wherein step (c) is performed by the steps of:
(c1) detecting the plurality of predetermined address codes at an interval of address codes; and
(c2) continuously detecting the plurality of predetermined address codes until the last physical predetermined address code is detected.

17. The method of claim 14, wherein step (c) is performed by the steps of:
(c1) detecting the plurality of predetermined address codes at an interval of address codes until a last detectable predetermined address code is detected; and
(c2) starting at the last detectable predetermined address code, detecting the plurality of predetermined address codes forward until the last physical predetermined address code is detected.

18. The method of claim 12, wherein said second optical information record medium has a pregroove on which plurality of predetermined address codes are marked, a predetermined information, recorded on said second optical information record medium, indicating a last possible predetermined address code of the plurality of predetermined address codes, and the second maximum storage capacity is determined by the steps of:
(c) retrieving the predetermined information from said second optical information record medium;
(d) according to the retrieved predetermined information, scanning the pregroove, and seeking out the last possible predetermined address code;
(e) starting at the last possible predetermined address code, scanning the pregroove forward until a last physical predetermined address code of the plurality of predetermined address codes is detected; and
(f) representing said second maximum storage capacity in terms of time with a time value representative of the detected last physical predetermined address code.

19. The method of claim 18, wherein the plurality of predetermined address codes, marked on the pregroove, are Absolute Time In Pregroove (ATIP) codes, and the predetermined information, recorded on said second optical information record medium, indicates the last possible ATIP code.

20. The method of claim 14, wherein step (e) is performed by the steps of:
(e1) detecting the plurality of predetermined address codes one by one; and
(e2) continuously detecting the plurality of predetermined address codes until the last physical predetermined address code is detected.

21. The method of claim 14, wherein step (e) is performed by the steps of:
(e1) detecting the plurality of predetermined address codes at an interval of address codes; and
(e2) continuously detecting the plurality of predetermined address codes until the last physical predetermined address code is detected.

22. The method of claim 14, wherein step (e) is performed by the steps of:
(e1) detecting the plurality of predetermined address codes at an interval of address codes until a last detectable predetermined address code is detected; and
(e2) starting at the last detectable predetermined address code, detecting the plurality of predetermined address codes forward until the last physical predetermined address code is detected.
